(19) United States
(12) Patent Application Publication
(10) Pub. No.: US 2026/0063109 A1
(43) Pub. Date: Mar. 5, 2026

(54) BIAXIAL SINGLE FREQUENCY FATIGUE TEST FOR WIND TURBINE BLADES

(71) Applicant: Envision Energy Co., Ltd., Jiangsu (CN)

(72) Inventors: IB FRYDENDAL, Silkeborg (DK); MICHAEL JOSEPH DESMOND, Silkeborg (DK)

(21) Appl. No.: 19/385,897

(22) Filed: Nov. 11, 2025

Related U.S. Application Data
(63) Continuation of application No. PCT/CN2024/103231, filed on Jul. 3, 2024.

(51) Int. Cl. F03D 17/00; G01M 7/02

(52) U.S. Cl. CPC F03D 17/011; F03D 17/028; G01M 7/022; G01M 7/025; F05B 2260/83

(57) ABSTRACT

A method and system of fatigue testing a wind turbine blade using a test system. The test system includes a test stand to which the wind turbine is fixed. A first excitation unit is connected to the wind turbine blade and used to introduce loadings in the flapwise direction. A second excitation unit is connected to the wind turbine blade and used to introduce loadings in the edge wise direction. A load controllable unit is further connected to the wind turbine blade and used to adjust the resonant frequency of the test system. Loadings in the flapwise and edgewise directions are introduced at the same resonant frequency and the loadings are measured using a number of detector units. The control unit monitor and control the amplitude of the first and second harmonic motions and the phase between the first and second harmonic motions.

### CROSS REFERENCE TO RELATED APPLICATIONS

The present application a continuation of PCT Patent Application No. PCT/CN2024/103231, entitled “BIAXIAL SINGLE FREQUENCY FATIGUE TEST FOR WIND TURBINE BLADES,” filed on Jul. 3, 2024, which is incorporated herein by reference in its entirety.

### TECHNICAL FIELD

The present invention relates to a biaxial resonant excitation method for structural fatigue testing of a wind turbine blade using one or more excitation units to introduce loadings simultaneously in the edgewise and flapwise directions. The structural fatigue testing is performed using a single frequency. One or more load controllable units are further attached to the wind turbine blade, which are used to adjust the resonant frequencies of the test system near to the singe frequency in both the edgewise and flapwise directions.

### BACKGROUND

It is known that wind turbine blades are designed with an aerodynamic outer profile extending along the length direction to optimize the extraction of wind energy at the installation site. Further, the wind turbine blades are designed with a structural strength to resist the dynamic and static loads during operation, idling and standstill modes. Static tests are performed on test blades to verify the wind turbine design parameters to withstand extreme loads. Fatigue tests are performed on test blades to verify the wind turbine design parameters to withstand fatigue loadings during the expected lifetime.

It is known to carry out fatigue blade testing at a resonant frequency along a single axis in the flapwise direction and in the edgewise direction, respectively. However, the loadings in the diagonal and all other directions between the two main directions are not tested properly. Further, this increases the total testing time and loads may deviate from field conditions, where the loads are combined in both directions for each rotation cycle.

One way to solve this problem is to carry out the fatigue blade testing simultaneously in the flapwise and edgewise directions using two resonant frequencies, one for each direction. This causes an uncontrolled combined motion of the wind turbine blade in the flapwise and edgewise directions during each load cycle (describing a Lissajous curve). In most cases where the structural properties are not modified, this results in overloading in the diagonal directions and in other directions between the two main directions during load cycles where the two resonant frequencies align with each other. There can be unique cases where the properties are modified such that the two frequencies align as a multiple of each other, for example 2:1 ratio resulting in a figure-eight motion. However, this too has undesirable loading in the off-axis directions, so this invention aims to eliminate those challenges by operating at a single controllable frequency while simultaneously loading both directions.

US 2017/0241860 A1 discloses a biaxial fatigue test system comprising a base for fixedly supporting the root end of the wind turbine blade, where an edgewise actuator assembly and a flapwise actuator assembly are attached to the wind turbine blade. The edgewise and flapwise actuator assemblies are operated at two resonant frequencies. The edgewise resonant frequency can be tuned prior to testing by adjusting the position of the pulley along the length of the moveable arm. Further, flapwise resonant frequency can be tuned by attaching additional weights to the wind turbine blade. However, it is silent about the control scheme used to control the flapwise and edgewise movements of the blade tip.

U.S. Pat. No. 8,621,934 B2 discloses another biaxial fatigue test system comprising a base for fixedly supporting the root end of the wind turbine blade, where an edgewise actuator assembly and a flapwise actuator assembly are attached to the wind turbine blade. The edgewise and flapwise actuator assemblies are operated at their distinct resonant frequencies.

U.S. Pat. No. 11,255,744 B2 discloses yet another biaxial fatigue test system operated at two resonant frequencies. Further, a liquid damper is attached to the wind turbine blade for tuning the load distribution in the flapwise and edgewise directions. This requires a complex control scheme and extra components to be arranged on the wind turbine blade.

US 2023/0060931 A1 discloses a biaxial test system, where the wind turbine blade is connected to passive load introduction units for adjusting the resonant frequency of the wind turbine blade. Active load introduction units are further connected to the wind turbine blade for applying a cyclic load. The resonant frequency of a first active load introduction unit in one direction is an integral multiple of the resonant frequency of a second active load introduction unit in another direction. The wind turbine blade is arranged in load frames with clamping blocks, where the load frames or clamping blocks are rotated around the longitudinal axis to adapt the moment vector paths generated by the active load introduction units to the distribution of the moment vector paths occurring in the field.

WO 2020/089038 A1 discloses a biaxial test system similar to US 2023/0060931 A1. The configurations of the active load introduction units are adjusted so a constant ratio between the resonant frequency of a first active load introduction unit in one direction and the resonant frequency of a second active load introduction unit in another direction is achieved. It is stated that when a ratio of 1:1 is selected, then the phase angle between the two resonant frequencies is set at 90 degrees. The phase angle and the ratio between resonant frequencies are set before the biaxial test, and no adjustment of the phase angle is performed during the biaxial test.

Therefore, there is a need for a fatigue blade test method that provides a more realistic loading.

### SUMMARY

One objective of the present disclosure is to achieve a method and system that solves the abovementioned problems of the known solutions.

One objective of the present disclosure is to achieve a method and system that allows for simultaneous testing in multiple directions and reduces total testing time.

One objective of the present disclosure is to achieve a method and system that allows for dynamically control of the elliptic motion of the wind turbine blade.

One objective of the present disclosure is to achieve a method and system that provides more realistic loading with respect to design or operational loadings.

One objective of the present invention is achieved by a method of testing a wind turbine blade, according to claim 1, wherein a target load polar plot is predetermined, and the method comprises the steps of:
attaching at least a first excitation unit to the wind turbine blade at a first longitudinal position, wherein the first excitation unit actively introduces loadings in the wind turbine blade in a flapwise direction at a first excitation frequency,
further attaching at least a second excitation unit to the wind turbine blade at a second longitudinal position, wherein the second excitation unit actively introduces loadings in the wind turbine blade in an edgewise direction at a second excitation frequency,
attaching at least one load controllable unit to the wind turbine blade at a third longitudinal position, where a resonant frequency of the test system in the flapwise direction and/or in the edgewise direction is adjusted by the at least one load controllable unit,
cyclic introducing loadings in the wind turbine blade by activation of the first and second excitation units to cause an elliptical motion of the wind turbine blade,
detecting at least the relative movement or loadings of the wind turbine blade using at least detector unit positioned relative to or on the wind turbine blade, where an output signal of the at least one detector unit is transmitted to the control unit,
wherein the control unit monitors and controls the elliptical motion pattern of the wind turbine blade by closed-loop controlling the first and second harmonic movements of the wind turbine blade and a phase between said first and second harmonic movements.

This provides an improved method of testing a wind turbine blade, where the biaxial fatigue testing is performed in the flapwise and edgewise directions simultaneously. The preset testing setup causes an elliptical motion of the wind turbine blade, thereby allowing for a more realistic loading with respect to the design or operational loads. Further, the overall testing time can be reduced as the fatigue testing is carried out in all directions at the same time.

According to the present inventive concept, the wind turbine blade is arranged in a test system forming a cantilever structure, where the blade root or a blade portion (e.g., a blade root portion) is fixed to a rigid reaction block (also known as a test stand). The tip end is thus able to move in both the flapwise and edgewise directions relative to the blade root end.

Excitation units are then attached to the wind turbine blade at dedicated longitudinal positions. The respective excitation units introduce loadings into the wind turbine blade in a flapwise direction and/or in an edgewise direction. Preferably, a first excitation unit may be used to introduce loadings at a first excitation frequency in the flapwise direction. Further, a second excitation unit may be used to introduce loadings at a second excitation frequency in the edgewise direction.

Load controllable units are attached to the wind turbine blade at dedicated longitudinal positions. Preferably, two or more load controllable units can be attached to the wind turbine blade at different longitudinal positions. The load controllable units are thus used to adjust the load distribution along the length of the wind turbine blade. Thereby, tuning the tip end of the wind turbine blade into an elliptical motion by adjusting a resonant frequency of the test system in the flapwise direction and/or in the edgewise direction.

Detector units detect or measure the movement of the wind turbine blade relative to its initial starting position. The starting position may be defined by a centreline extending through the blade root and the tip end. The detector units may also measure the loading of the wind turbine blade relative to its initial unloaded state. The output signals of the detector units are transmitted to a control unit of the test system for further data processing. This allows the cyclic loadings and/or elliptical motion of the wind turbine blade to be measured, directly or indirectly, using different types of detector units.

The control unit analyses the received output signals of the detector units to determine the cyclic loadings and/or elliptical motion of the wind turbine blade. Further, the control unit generates a load polar plot of the loadings in the flapwise and edgewise directions, respectively. The received output signals of the detector units may be processed using known algorithms.

The elliptical motion may be described by a major axis and a minor axis, each extending through a centre-point of the ellipse. Further, the ellipse can be rotated so that an angle is formed between the major axis and the X-axis of the polar plot. This elliptical motion can be described by a formula descriptive of the coordinates of the harmonic motions in flapwise and edgewise directions, respectively, in the polar plot. The output of this formula generates a first and a second amplitude where a phase offset, or phase, is formed between the first and second amplitudes. This allows the elliptical motion to be transformed into quantifiable parameters for the control scheme implemented in the control unit.

The control unit monitors and controls the elliptical motion pattern of the wind turbine blade based on the detected or measured output signals of the detector units. Preferably, the control unit performs closed-loop control of the elliptical motion pattern compared to other known solutions. This allows for an improved control of the biaxial fatigue test of the wind turbine blade.

In one embodiment, the control unit dynamically adjusts the elliptical motion pattern to match the target load polar plot during testing.

Further, a setpoint may be inputted into the control unit where the control unit automatically may regulate the parameters of the test system to adjust and maintain the actual loadings at the desired set-point. Preferably, a target load plot profile may be implemented into the control unit and used as a set-point for the fatigue testing. This allows the control unit to accurately match the elliptical motion of the wind turbine blade to the target load plot profile during fatigue testing. Further, this adjustment can be performed within a few load runs compared to other known solutions.

This may be achieved by simply adjusting the resonant frequencies of the test system by actively changing the configuration of the load controllable units. Thus, allowing the parameters of the fatigue testing process to be changed between different load profiles automatically and in real-time. No need to stop the fatigue testing process to adjust the configuration of the load controllable units. Thereby further reducing the overall testing time.

In one embodiment, the first excitation frequency is equal to the second excitation frequency so that loadings are introduced at the same resonant frequency.

Unlike known solutions, loadings in the present method are introduced in both the flapwise and edgewise directions at the same resonant frequency. This produces cyclic loadings, and thus elliptical motion, where the load peaks in the flapwise and edgewise directions can be controlled and separated by the control unit. Further, this allows the control unit to generate a very accurate load plot of the loadings.

In one embodiment, the control unit performs closed-loop control of the phase shift between first harmonic motions in the flapwise direction and second harmonic motions in the edgewise direction.

The present method allows the control unit to control a phase shift between the first and second amplitudes. Preferably, the control unit may perform closed-loop of the phase shift between the flapwise and edgewise directions, thus producing a phase-locked offset between the first and second harmonic motions. This may be achieved by actively changing the loadings, e.g., inertia, introduced in the edgewise direction. If the phase shift between the flapwise and edgewise directions is too high, then the loading, e.g., inertia, in the edgewise direction is reduced which leads to a higher second excitation frequency. Thereby, changing the cycle time which in turn leads to a change of the phase shift.

In one embodiment, a first amplitude of the first harmonic motions and a second amplitude of the second harmonic motions are controlled independently by the control unit.

The present method allows the peak loads of the elliptical motion to be separated and controlled by the control unit. The control unit may further be configured to control and adjust the first and second amplitudes independently, thus allowing for a more accurate adjustment of the loadings in the flapwise and edgewise directions.

In one embodiment, the load controllable unit is an inertia unit, where actively changing an inertia of the inertia unit causes a change in the inertia introduced in the edgewise direction.

The loadings introduced in the edgewise direction may be actively changed using one or more inertia units attached to the wind turbine blade. The inertia units may have a changeable configuration so that the inertia in the inertia unit can be changed automatically under control of the control unit. The inertia may be changed by transmitting control signals from the control unit to the respective inertia units. The loadings introduced in the edgewise direction may be measured using the detector units. The set-point and measured loadings may be used by the control unit to control the inertia of the inertia units.

In one embodiment, the load controllable unit is a stiffness unit, where actively changing a stiffness of the stiffness unit causes a change in the stiffness introduced in the flapwise direction.

The loadings introduced in the flapwise direction may be actively changed using one or more stiffness units attached to the wind turbine blade. The stiffness units may have a changeable configuration so that the stiffness in the stiffness unit can be changed automatically under control of the control unit. The stiffness may be changed by transmitting control signals from the control unit to the respective stiffness units. The loadings introduced in the flapwise direction may be measured using the detector units. The set-point and measured loadings may be used by the control unit to control the stiffness of the stiffness units.

The same resonant frequency of the test system may be obtained by combining the adjustment of the stiffness in the flapwise direction and the adjustment of the inertia in the edgewise direction.

In one embodiment, introducing further loadings in the wind turbine blade by at least one passive load unit.

Further loadings may be further introduced in the edgewise direction and/or in the flapwise direction by passive load units. Unlike the load controllable units, the passive load units are not actively controlled by the control unit but introduces constant loadings. The passive load unit may introduce a preset loading in the edgewise or flapwise direction.

One objective of the present invention is achieved by a test system, according to claim 9, for testing a wind turbine blade, wherein a target load polar plot is predetermined, and the test system comprising:
a test stand configured to receive and support the wind turbine blade during testing,
at least a first excitation unit configured to be attached to the wind turbine blade at a first longitudinal position, the first excitation unit being configured to actively introduce loadings in the wind turbine blade in a flapwise direction at a first excitation frequency,
at least a second excitation unit configured to be attached to the wind turbine blade at a second longitudinal position, the second excitation unit being configured to actively introduce loadings in the wind turbine blade in an edgewise direction at a second excitation frequency,
at least one load controllable unit configured to attached to the wind turbine blade at a third longitudinal position, the at least one load controllable unit being configured to adjust a resonant frequency of the test system in the flapwise direction and/or in the edgewise direction,
a control unit electrically connected to the first and second excitation units, wherein the control unit is configured to control the cyclic loading introduced in the wind turbine blade by transmitting control signals to the first and second excitation units,
at least one detector unit positioned relative to or on the wind turbine blade and connected to the control unit, wherein the at least one detector unit is configured to detect at least the relative movement or loadings of the wind turbine blade and to transmit at least one output signal to the control unit,
wherein the control unit is configured to monitor and control an elliptical motion pattern of the wind turbine blade by closed-loop controlling the first and second harmonic movements of the wind turbine blade and a phase between said first and second harmonic movements.

This provides an improved testing setup, where the biaxial fatigue testing is performed on a wind turbine blade in the flapwise and edgewise directions simultaneously. The preset testing setup causes an elliptical motion of the wind turbine blade, thereby allowing for a more realistic loading with respect to the design or operational loads. Further, the overall testing time can be reduced as the fatigue testing is carried out in all directions at the same time.

According to the present inventive concept, the test system is configured to receive and hold the wind turbine blade in a test position, thereby forming a cantilever structure. The test system comprises a test stand, to which the wind turbine blade can be connected. Preferably, the test stand comprises a mounting interface configured to receive the blade root end or blade portion of the wind turbine blade and to hold it in a fixed position. This allows the tip end to move in both the flapwise and edgewise directions relative to the blade root end.

One or more excitation units are configured to be attached to the wind turbine at dedicated loading positions along the length of the wind turbine blade. The respective excitation units are configured to introduce loadings into the wind turbine blade in a flapwise direction and/or in an edgewise direction. Preferably, a first excitation unit can introduce loadings at a first excitation frequency in the flapwise direction. Further, a second excitation unit can introduce loadings at a second excitation frequency in the edgewise direction. Alternatively, a combined excitation unit may be configured to introduce loadings in both the flapwise and edgewise directions at dedicated excitation frequencies. Upon activation, the excitation units cause cyclic loadings in the wind turbine blade in the flapwise and edgewise directions.

Further, one or more load controllable units are configured to be attached to the wind turbine blade at dedicated loading positions along the length of the wind turbine blade. A single or multiple load controllable unit can be attached to the wind turbine blade at one or more longitudinal positions. The load controllable units are configured to adjust the resonant frequencies of the test system in the flapwise direction and/or in the edgewise direction. This allows the tip end to be tuned to follow an elliptical motion pattern.

One or more detector units are configured to detect the movement of the wind turbine blade relative to its initial starting position. The detector units may also be configured to measure, directly or indirectly, the cyclic loading of the wind turbine blade. Further, the individual detector units may be electrically connected, wired or wirelessly, to the con-trol unit, which is configured to process the measured or detected signals. Different types of detector units may be used to detect or measure different types of signals.

The control unit comprises a microprocessor connected to a database, where executable computer instructions are implemented in the microprocessor. The output signals of the detector units and/or the generated data of the control unit may be stored in the database. As described earlier, a formula descriptive of the coordinates of the harmonic motions in flapwise and edgewise directions, respectively, in the polar plot is implemented in the control unit. This allows the elliptical motion to be transformed into quantifiable parameters for the control scheme implemented in the control unit.

Further, the control unit is configured to monitor and control the elliptical motion pattern of the wind turbine blade based on the detected or measured output signals of the detector units. In a preferred configuration, the control unit is configured to perform closed-loop control of the elliptical motion pattern whereas known solutions use an open loop control. Further, known solutions do not vary the resonant frequency dynamically during the fatigue testing. This allows for an improved control of the biaxial fatigue test of the wind turbine blade.

In one embodiment, the control unit is configured to dynamically adjust the elliptical motion pattern to match the target load polar plot during testing.

The control unit may be configured to receive a set-point, e.g., a target load plot profile, and store it in the database. Further, the control unit may be configured to automatically regulate the parameters of the test system according to the set-point in real-time. Preferably, the elliptical motion may be adjusted by the control unit to match the target load plot. This allows the control unit to accurately match the elliptical motion of the wind turbine blade to the target load plot profile during fatigue testing. Further, this adjustment can be performed within a few load runs compared to other known solutions.

This may be achieved by the control unit being configured to actively changing the configuration of the load controllable units to adjust the resonant frequencies of the test system. Thereby, allowing the parameters of the fatigue testing process to be changed between different load profiles automatically. No need to stop the fatigue testing process to adjust the configuration of the load controllable units. Thereby further reducing the overall testing time.

In one embodiment, the first and second excitation units are configured to introduce loadings in the wind turbine blade at the same excitation frequency.

As described earlier, loadings in the present method are introduced in both the flapwise and edgewise directions at the same resonant frequency. This produces cyclic loadings, and thus elliptical motion, where the load peaks in the flapwise and edgewise directions can be controlled and separated by the control unit. Further, this allows the control unit to generate a very accurate load plot of the loadings.

In one embodiment, the control unit is configured to closed-loop control the phase shift between first harmonic motions in the flapwise direction and second harmonic motions in the edgewise direction.

The present control unit may be configured to control a phase shift between the first and second amplitudes outputted by the control unit. Preferably, the control unit may be configured to perform closed-loop control of the phase shift between the flapwise and edgewise directions. This may be achieved by the control unit actively changing the configuration of the second excitation unit so that the loadings, e.g., inertia, intruded in the edgewise direction is adjusted. If the phase shift between the flapwise and edgewise directions is too high, then the loading, e.g., inertia, in the edgewise direction is changed which leads to a changed second excitation frequency. Thereby, changing the cycle time which in turn leads to a change of the phase shift.

In one embodiment, the load controllable unit is an inertia unit, wherein the inertia unit is adjustable so that the inertia introduced in the edgewise direction can be actively changed.

The load controllable unit may be an inertia unit having an adjustable configuration so that the inertia of the inertia unit can be changed. Preferably, the inertia of the inertia unit may be adjusted automatically under control of the control unit. A single or multiple inertia units may be used to adjust the inertia introduced in the edgewise direction.

The control unit may transmit control signals to the respective inertia units, which then adjust the inertia accordingly. The loadings introduced in the edgewise direction may be measured using the detector units, which together with the set-point may be used by the control unit to control the inertia of the inertia units.

The inertia unit may comprise a frame structure on which one or more masses may be moveable arranged. Each mass may be positioned relative to a pivot point of the inertia unit so that the mass introduces a moment of inertia. The mass may be connected to an actuator of the inertia unit to automatically move mass closer to or further away from the pivot point. Further, the inertia unit may have a vertical or horizontal rotation axis around which the masses and/or actuators can rotate. Other known configurations of the inertia unit may also be used. This provides a simple and light-weight way to introduce inertia into the wind turbine blade.

In one embodiment, the load controllable unit is a stiffness unit, wherein the configuration of the stiffness unit is changeable so that the stiffness introduced in the flapwise direction can be actively changed.

Preferably, the stiffness of the stiffness unit may be adjusted automatically under control of the control unit. A single or multiple stiffness units may be used to adjust the stiffness introduced in the flapwise direction.

The control unit may transmit control signals to the respective stiffness units, which then adjust the stiffness accordingly. The loadings introduced in the flapwise direction may be measured using the detector units, which together with the set-point may be used by the control unit to control the stiffness of the stiffness units.

The same resonant frequency of the test system may be obtained by combining the adjustment of the stiffness in the flapwise direction and the adjustment of the inertia in the edgewise direction. The stiffness units and inertia units may be controlled by the control unit.

The stiffness unit may comprise at least one deformable element attached directly between the ground level and at least one saddle arranged on the wind turbine blade via one or more pivotal connections. The deformable element may be a spring, a gas tank with moveable piston, a bendable plate or plate structure. Other known configurations of the stiffness unit may also be used.

The plate or plate structure may be attached to two or more saddles and to a common pivot point at the ground level.

In one embodiment, at least one passive load unit is further connected to the wind turbine blade, wherein in the at least passive load unit is positioned relative to the at least one load controllable unit.

The load controllable units may be combined with one or more passive load units. The passive load unit may be configured to introduce a predetermined or nominal loading in the wind turbine blade in the edgewise direction and/or in the flapwise direction. The passive load unit may act as a passive follower with a moveable pendulum. Alternatively, the passive unit may have a configuration similar to the load controllable unit, but without the actuators. Thus, the masses may be arranged in a fixed position relative to the pivot point. Other configurations may also be used.

At least one or all load units attached to the wind turbine blade may be load controllable units.

### BRIEF DESCRIPTION OF THE DRAWINGS

Various examples are described hereinafter with reference to the figures. Like reference numerals refer to like elements throughout. Like elements will, thus, not be described in detail with respect to the description of each figure. It should also be noted that the figures are only intended to facilitate the description of the examples. They are not intended as an exhaustive description of the claimed invention or as a limitation on the scope of the claimed invention. In addition, an illustrated example need not have all the aspects or advantages shown.

An aspect or an advantage described in conjunction with a particular example is not necessarily limited to that example and can be practiced in any other examples even if not so illustrated, or if not so explicitly described.

Exemplary embodiments of the invention are described in the figures, whereon:

FIG. 1 illustrates an example of a wind turbine,

FIG. 2 illustrates an exemplary embodiment of a test system according to present invention,

FIG. 3 illustrates an exemplary load polar plot of an elliptical motion of the wind turbine blade,

FIG. 4 illustrates an exemplary graph of the first and second harmonic motions,

FIG. 5 illustrates an exemplary load polar plot before calibration of the fatigue test,

FIG. 6 illustrates an exemplary load polar plot after calibration of the fatigue test,

FIG. 7 illustrates a first embodiment of an inertia unit according to the present invention,

FIG. 8 illustrates a second embodiment of the inertia unit,

FIG. 9 illustrates a third embodiment of the inertia unit, and

FIG. 10 illustrates an embodiment of a stiffness unit according to the present invention.

### DETAILED DESCRIPTION OF THE EMBODIMENTS

Exemplary examples will now be described more fully hereinafter with reference to the accompanying drawings. In this regard, the present examples may have different forms and should not be construed as being limited to the descriptions set forth herein. Accordingly, the examples are merely described below, by referring to the figures, to explain aspects.

Throughout the specification, when an element is referred to as being “connected” to another element, the element is “directly connected” to the other element, “electrically connected”, “fluidic connected” or “communicatively connected” to the other element with one or more intervening elements interposed there between.

The terminology used herein is for the purpose of describing particular examples only and is not intended to be limiting. As used herein, the terms “comprises” “comprising” “includes” and/or “including” when used in this specification specify the presence of stated features, integers, steps, operations, elements, and/or components, but do not preclude the presence or addition of one or more other features, integers, steps, operations, elements, components, and/or groups thereof.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined in the present specification.

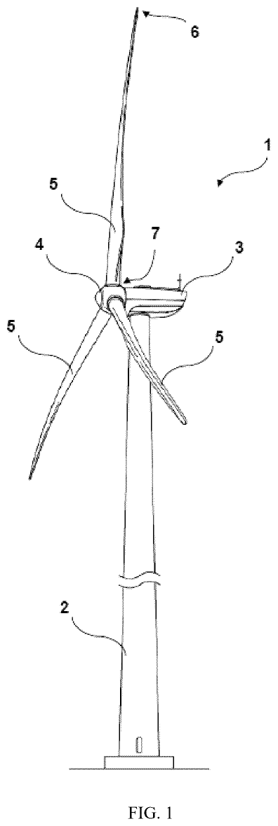

FIG. 1 illustrates an example of a horizontal-axis wind turbine (HAWT) 1 comprising a wind turbine tower 2, a nacelle 3 arranged on top of the wind turbine tower 2, and a rotor connected to a drive train in the nacelle 3. The rotor comprises a hub 4 and a number of wind turbine blade(s) 5 connected to the hub 4. Here, three wind turbine blades 5 are shown, but the hub 4 may be connected to more or less wind turbine blades 5.

The wind turbine 1 is here shown as an onshore wind turbine, but the wind turbine 1 may also be an offshore wind turbine 1. The wind turbine blade may be a continuous wind turbine blade or a modular wind turbine blade. The wind turbine blade 5 extends from a blade root end 7 to a tip end 6 and comprises a pressure side and a suction side.

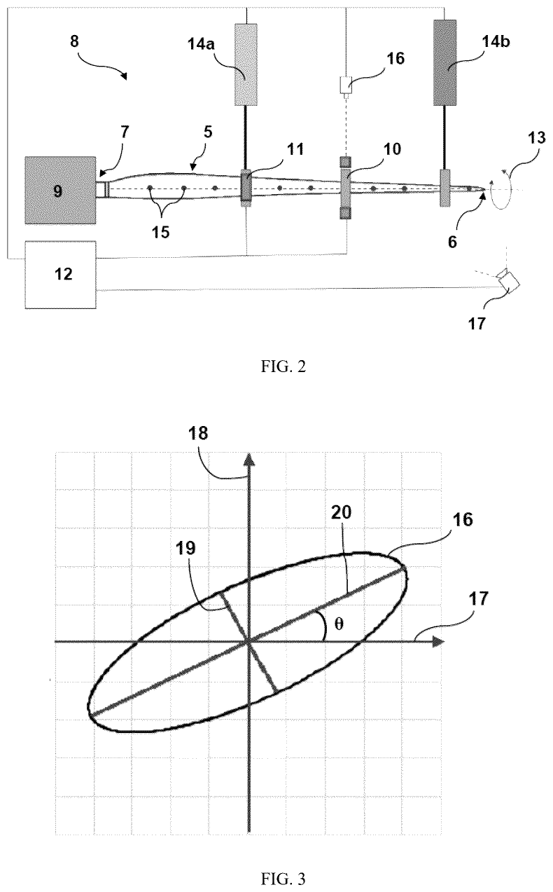

FIG. 2 illustrates an exemplary embodiment of a test system 8 for performing a fatigue testing of the wind turbine blade 5. The blade root end 7 may be attached to a test stand 9 at a fixed position. The rest of the wind turbine blade 5 extends in a longitudinal direction so the tip end 6 is able to move in a flapwise and an edgewise direction.

A first excitation unit 10 and a second excitation unit 11 are arranged on or attached to the wind turbine blade 5 at dedicated positions along the length of the wind turbine blade 5. The first excitation unit 10 is configured to introduce loadings in the wind turbine blade 5 in the flapwise direction. The second excitation unit 11 is configured to introduce loadings in the wind turbine blade 5 in the edgewise direction. The first and second excitation units 10, 11 are electrically connected to a control unit 12, which controls the loadings introduced in the flapwise and edgewise directions.

At one load unit 14a, 14b are arranged on or attached to the wind turbine blade 5 at dedicated positions along the length of the wind turbine blade 5. The load unit may be formed as a controllable unit 14b is configured to introduce adjustable loading into the wind turbine blade 5 in the flapwise and/or edgewise direction. The loading of the load controllable unit 14b is actively controlled by the control unit 12. The control unit 12 adjust the loading of the load controllable unit 14b so that the loadings in the flapwise and edgewise direction are introduced at the same resonant frequency of the test system 8. This causes an elliptical motion 13 of the wind turbine blade 5.

Alternatively, one or more of the above load units may be formed as passive load units 14a, which are configured to introduce a nominal loading into the wind turbine blade 5 in the flapwise and/or edgewise direction.

Detector units 15, 16, 17 electrically connected to the control unit 12 are used to detect or measure the cyclic loadings or elliptical motion of the wind turbine blade 5. Detector units in the form of sensors 15, e.g., strain gauges, may be arranged on the pressure or suction side of the wind turbine blade 5. Detector units in the form of range finders, e.g., laser range finders, may be arrange relative to the wind turbine blade 5, e.g., the saddles positioned on the wind turbine blade 5. Detector units in the form of cameras 17 may be arrange relative to the wind turbine blade 5. The output signals of the detector units 15, 16, 17 are transmitted to the control unit 12 and processed to determine the loadings of the wind turbine blade in the flapwise and edgewise directions.

FIG. 3 illustrates an exemplary load polar plot 16 of the elliptical motion of the wind turbine blade 5. The X-axis 17 indicates the movement in the edgewise direction and the Y-axis 18 indicates the movement in the flapwise direction. The elliptical motion is described by a major axis 20 and a minor axis 19 extending through a centre-point of the ellipse. The ellipse is here rotated relative to the X-axis 17 by an angle θ.

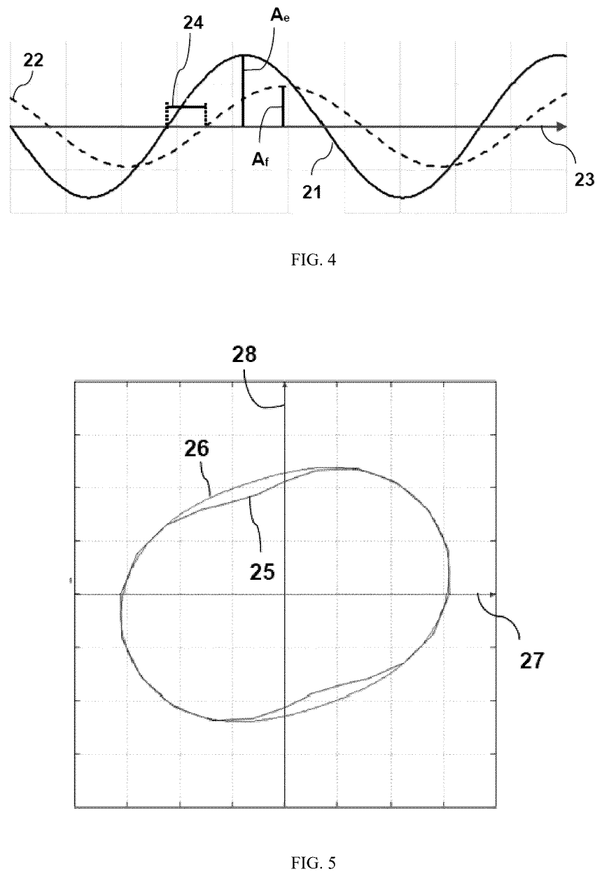

FIG. 4 illustrates an exemplary graph of the first and second harmonic motions 21, 22 of the wind turbine blade 5 in the flapwise and edgewise directions. The X-axis 23 indicates time. A phase 24 is provided between a first amplitude Af and a second amplitude Ae of the first and second harmonic motions 21, 22. The first and second harmonic motions 21, 22 and the phase 24 are outputted by the control unit 12 and descriptive of the elliptical motion 16 shown in FIG. 3.

FIG. 5 illustrates an exemplary load polar plot before calibration of the fatigue test. The X-axis 27 indicates the movement in the edgewise direction and the Y-axis 28 indicates the movement in the flapwise direction. A target load polar plot 25 is inputted to the control unit 12. The control unit 12 determines the actual load polar plot 26 of the test system 8.

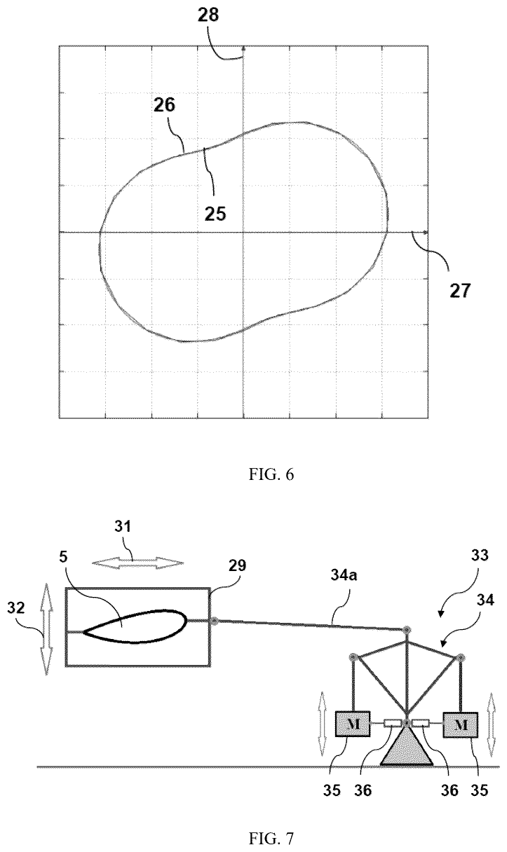

FIG. 6 illustrates an exemplary load polar plot after calibration of the fatigue test. The calibration is performed by adjusting the loadings of the load controllable unit 14b and measuring the loadings over a number of runs. As illustrated, the actual load polar plot 26 can be adjusted to match the target load polar plot 25 by use of the preset control scheme.

FIG. 7 illustrates a first embodiment of an inertia unit 33 according to the present invention. The inertia unit 33 comprises a frame structure 34 connected to a saddle 29 arranged on the wind turbine blade 5 via a rod connection 34a. The inertia unit 33 further comprises at least one mass 35 connected to an actuator 36, which in turn is connected to a pivot point on the frame structure 34. The operation of the actuator 36 is controlled by the control unit 12, where activation of the actuator 36 causes an adjustment of the inertia in the inertia unit 33.

The inertia of the inertia unit 33 is introduced in the flapwise direction 32 and/or in the edgewise direction 31.

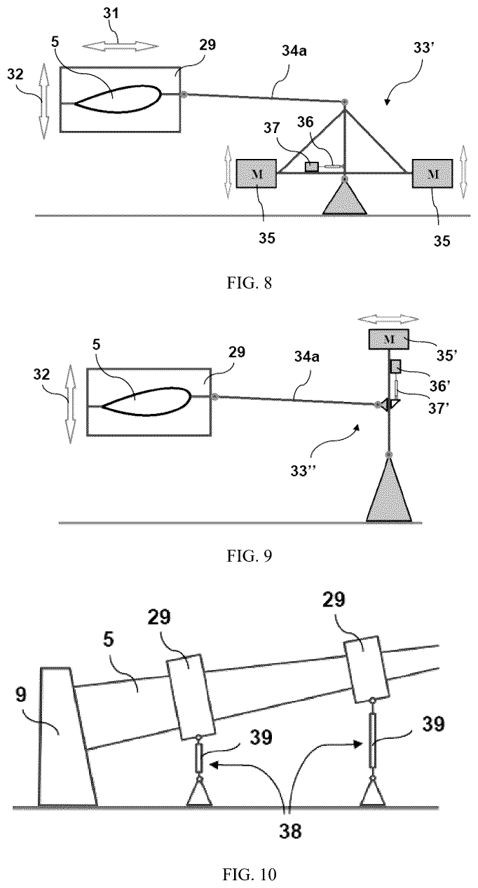

FIG. 8 illustrates a second embodiment of the inertia unit 33′, where the inertia unit 33′ comprises masses 35 at fixed positions and additional masses 37 connected to the actuators 36. The additional masses 37 are moved by the actuators 36, which are controlled by the control unit 12.

FIG. 9 illustrates a third embodiment of the inertia unit 33′, where the mass 36′ and actuator 37′ are arranged vertically compared to the horizontal orientation in FIGS. 7-8.

FIG. 10 illustrates an embodiment of a stiffness unit 38 according to the present invention. The stiffness unit 38 comprises at least one deformable element 39, e.g., a spring, attached to the saddle 29 and to the ground level. The spring stiffness of the stiffness unit may be controllable by the control unit.

Those of ordinary skill in the art can understand that the aforementioned embodiments are specific examples for implementing the present disclosure. In practical applications, various modifications can be made to them in form and detail without deviating from the spirit and scope of the present disclosure. A person skilled in the art may make various alterations and modifications without departing from the spirit and scope of the present disclosure, and thus the scope of protection of the present disclosure should be determined by the scope of the appended claims.

What is claimed is:

1. A method of testing a wind turbine blade, comprising:
attaching at least one first excitation unit to the wind turbine blade at a first longitudinal position;
attaching at least one second excitation unit to the wind turbine blade at a second longitudinal position;
attaching at least one load controllable unit to the wind turbine blade at a third longitudinal position;
cyclically introducing loadings in the wind turbine blade by activation of the first and second excitation units to cause an elliptical motion of the wind turbine blade, including controlling the at least one first excitation unit to actively introduce loadings in the wind turbine blade in a flapwise direction at a first excitation frequency, controlling the at least one second excitation unit to actively introduce loadings in the wind turbine blade in an edgewise direction at a second excitation frequency, and controlling the at least one load controllable unit to adjusts a resonant frequency in the flapwise direction and/or in the edgewise direction; and
detecting at least relative movement or loadings of the wind turbine blade at one or more locations on the wind turbine blade,
monitoring and controlling an elliptical motion pattern of the wind turbine blade by closed-loop controlling first and second harmonic movements of the wind turbine blade and a phase (θ) between the first and second harmonic movements.

2. The method according to claim 1, further comprising adjusting the elliptical motion pattern to match a predetermined target load polar plot during testing.

3. The method according to claim 1, wherein the first excitation frequency is equal to the second excitation frequency so loadings are introduced at a same resonant frequency.

4. The method according to claim 1, wherein the control unit performs closed-loop control of a phase shift between first harmonic motions in the flapwise direction and second harmonic motions in the edgewise direction.

5. The method according to claim 1, wherein a first amplitude of the first harmonic motions and a second amplitude of the second harmonic motions are controlled independently by the control unit.

6. The method according to claim 1, wherein the load controllable unit is an inertia unit, wherein actively changing an inertia of the inertia unit causes a change in an inertia introduced in the edgewise direction.

7. The method according to claim 1, wherein the load controllable unit is a stiffness unit, wherein actively changing a stiffness of the stiffness unit causes a change in a stiffness introduced in the flapwise direction.

8. The method according to claim 1, comprising introducing further loadings in the wind turbine blade by at least one passive load unit.

9. The method according to claim 2, comprising introducing further loadings in the wind turbine blade by at least one passive load unit.

10. The method according to claim 3, comprising introducing further loadings in the wind turbine blade by at least one passive load unit.

11. The method according to claim 4, comprising introducing further loadings in the wind turbine blade by at least one passive load unit.

12. The method according to claim 5, comprising introducing further loadings in the wind turbine blade by at least one passive load unit.

13. The method according to claim 6, comprising introducing further loadings in the wind turbine blade by at least one passive load unit.

14. A test system for testing a wind turbine blade, comprising:
a test stand configured to receive and support the wind turbine blade during testing,
at least one first excitation unit configured to be attached to the wind turbine blade at a first longitudinal position, the at least one first excitation unit being configured to actively introduce loadings in the wind turbine blade in a flapwise direction at a first excitation frequency,
at least one second excitation unit configured to be attached to the wind turbine blade at a second longitudinal position, the at least one second excitation unit being configured to actively introduce loadings in the wind turbine blade in an edgewise direction at a second excitation frequency,
at least one load controllable unit configured to attached to the wind turbine blade at a third longitudinal position, the at least one load controllable unit being configured to adjust a resonant frequency of the test system in the flapwise direction and/or in the edgewise direction,
a control unit electrically connected to the first and second excitation units, wherein the control unit is configured to control cyclic loadings introduced in the wind turbine blade by transmitting control signals to the first and second excitation units,
at least one detector unit positioned at one or more locations on the wind turbine blade and connected to the control unit, wherein the at least one detector unit is configured to detect relative movement or loadings of the wind turbine blade and to transmit at least one output signal to the control unit,
wherein the control unit is configured to monitor and control an elliptical motion pattern of the wind turbine blade by closed-loop controlling first and second harmonic movements of the wind turbine blade and a phase between the first and second harmonic movement in a closed control loop.

15. The test system according to claim 14, wherein the control unit is configured to dynamically adjust the elliptical motion pattern to match a predetermined target load polar plot during testing.

16. The test system according to claim 14, wherein the first and second excitation units are configured to introduce loadings in the wind turbine blade at a same excitation frequency.

17. The test system according to claim 14, wherein the control unit is configured to closed-loop control a phase shift between first harmonic motions in the flapwise direction and second harmonic motions in the edgewise direction.

18. The test system according to claim 14, wherein the load controllable unit is an inertia unit, wherein the inertia unit is adjustable so that an inertia introduced in the edgewise direction is actively changeable.

19. The test system according to claim 14, wherein the load controllable unit is a stiffness unit, wherein a stiffness of the stiffness unit is changeable so that a stiffness introduced in the flapwise direction is actively changeable.

20. The test system according to claim 14, wherein at least one passive load unit is further connected to the wind turbine blade, wherein the at least one passive load unit is positioned relative to the at least one load controllable unit.
